(19) United States
(12) Patent Application Publication
(10) Pub. No.: US 2023/0291739 A1
(43) Pub. Date: Sep. 14, 2023

(54) SYSTEM AND METHOD FOR CLOUD-BASED SCAN TO EMAIL BLACKLIST

(71) Applicant: Toshiba TEC Kabushiki Kaisha, Shinagawa-ku (JP)

(72) Inventor: Adrian NIELSON, Lake Forest, CA (US)

(21) Appl. No.: 17/693,588

(22) Filed: Mar. 14, 2022

(51) Int. Cl. H04L 9/40; H04L 51/212; H04N 1/00

(52) U.S. Cl. CPC H04L 63/102; H04L 51/212; H04N 1/00413; H04N 1/00875; H04N 1/00212; H04N 1/00225

(57) ABSTRACT

A system and method for cloud based blacklisting of public email services from scan to email operations includes a cloud server where a blacklist is created and maintained by an administrator for one or more multifunction peripherals having IP addresses in a selected subnet. When a multifunction peripheral receives a scan to email instruction with an associated email address from a user, it requests a copy of the blacklist from the cloud server. The cloud server sends the blacklist to the multifunction peripheral if it has an IP address in the authorized subnet. The multifunction peripheral checks the destination email address and completes the scan to email operation if a domain associated with the email address is not in the blacklist. If the domain is in the blacklist, a copy of a scan file from the document scan, along with information about the multifunction peripheral being used, and time and date of the scan is sent to the administrator without informing the user that the email with the scan file is unsent.

### TECHNICAL FIELD OF THE INVENTION

This application relates generally to scan to email printing. The application relates more particularly to the use of cloud-based blacklist information to prevent a scan to email on a public email server with administrator notification when attempted.

### BACKGROUND OF THE INVENTION

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Document processing functions of MFPs can be used to secure copies of sensitive or valuable information.

### BRIEF DESCRIPTION OF THE DRAWINGS

Various embodiments will become better understood with regard to the following description, appended claims and accompanying drawings wherein:

FIG. 1 is an example embodiment of a system for implementing a cloud-based scan to email blacklist screening for scan to email operations on a multifunction peripheral;

FIG. 2 is an example embodiment of a networked digital device, such as a multifunction peripheral;

FIG. 3 is an example embodiment of a digital device system, such as a server or a workstation;

FIG. 4 is a flowchart of an example embodiment of a system for implementing a cloud-based scan to email blacklist screening for scan to email operations; and

FIG. 5 is a flowchart of an example embodiment of creating and accessing a cloud server blacklist.

### DETAILED DESCRIPTION OF THE INVENTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

MFPs are ubiquitous in office environments, including environments that have sensitive or valuable information, such as with documents containing trade secrets, personal information or copyrighted information. A user could walk up to an MFP and simply make a hard copy of documents. However, MFPs can readily track copying operations, including an identity of a user, a timing of a copy or a number of copied pages. MFPs can even monitor content of copied documents or prevent copying of certain documents, such as documents bearing a particular indicia. A user can also scan documents into electronic files. In secure environments, an MFP may be secured from writing to portable storage devices such as flash drives or disks. MFPs have more recently been enabled to scan to email where a user enters a destination email address. A scanned document is automatically attached to and sent as outgoing email. There is typically little or no restrictions to sending documents in this fashion. This leaves a window of vulnerability for a leak of sensitive or valuable information.

In example embodiments herein, an MFP reads from a cloud-based e-mail domain blacklist which is used when a scan to email application scans a document. If such a document is scanned and the destination e-mail address is on the blacklist, the document will be scanned, but not sent out as an email attachment. An e-mail alert is sent to a network administrator with a copy of the scanned document, the IP address of the MFP along with its location within the building, including the input destination e-mail address and the date and time attempted transmission.

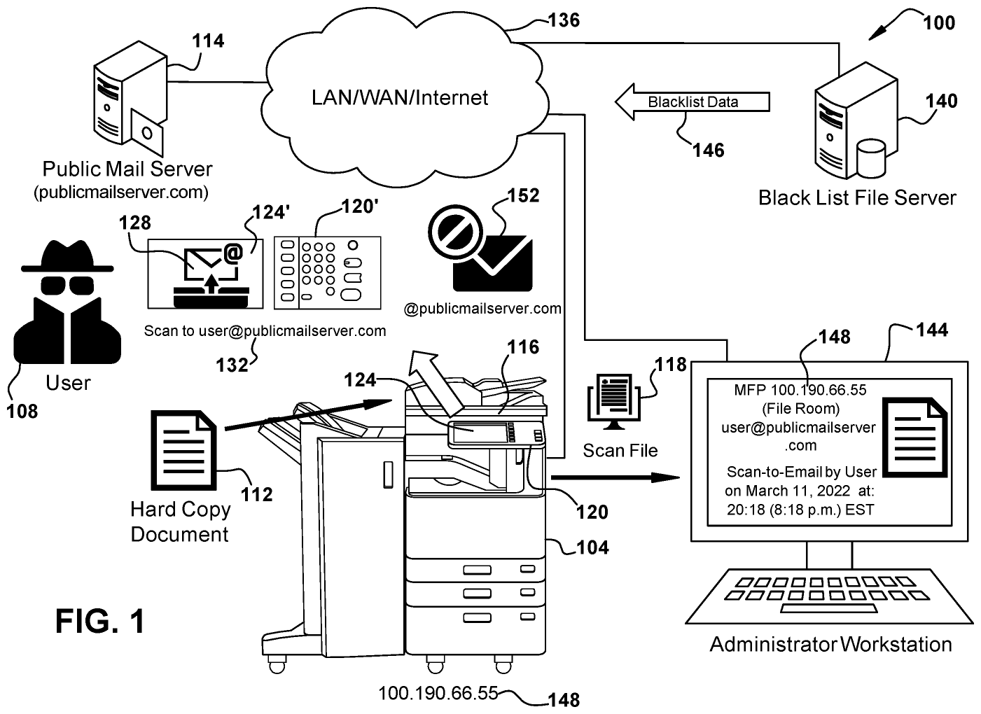

FIG. 1 illustrates a system 100 for implementing a cloud-based scan to email blacklist screening for scan to email operations on MFP 104. Nefarious user 108 wishes to scan confidential hard copy document 112 and email it to their email account on public mail server 114. By of example, public email servers may comprise one or more of services such Gmail, HubSpot, Sendinblue, ProtonMail, Outlook, Yahoo Mail, Zoho Mail, Mail.com, GMX Mail, iCloud Mail and Yandex Mail. User 108 uses scanner 116 of MFP 104 to generate an electronic copy or scan file 118. MFP 104 includes a user interface 120 including a display 124 and user input, shown in an exploded view as 120′ and 124′ and suitably realized with a touchscreen.

User 108 inputs a scan to mail command 128 and destination email address 132 into user interface 120, suitably launching a scan to email application on MFP 104.

Included in FIG. 1 is network cloud 136, suitably comprised of a local area network (LAN), a wide area network (WAN), which may comprise the Internet, or any suitable combination thereof. Network cloud 136 is comprised of any suitable wireless or wired data connection or combination thereof. Network cloud 136 places MFP 104 in data communication with public mail server 114, as well as with black list file server 140 and administrator workstation 144.

After scan file 118 is created, MFP 104 contacts black list file server 140 and requests a copy of a black list associated with its network. If authorized, blacklist server 140 sends blacklist data 146 to MFP 104 which determines if a domain associated with email address is in the blacklist. If not, scan file 118 is attached to an email and sent to email address 132 on public mail server 114. If the domain is the blacklist, a message, suitably an email message, is sent to administrator workstation 144 with scan file 118 as an attachment. No email is created and sent to email address 132. Information in the administrator email message includes useful information, such as IP address 148 of MFP 104, email address 132, confirmation of a received scan to email instruction, an identification of user 108 and a time and date of the attempted transmission. A copy of scan file 118 is attached to the administrator notification email message. User 108 is uninformed when their email 152 has been blocked. A message confirming a transmission of the user's email may be displayed on user interface 120 irrespective as to whether the email was sent or not, allowing an administrator a window of time to address the situation.

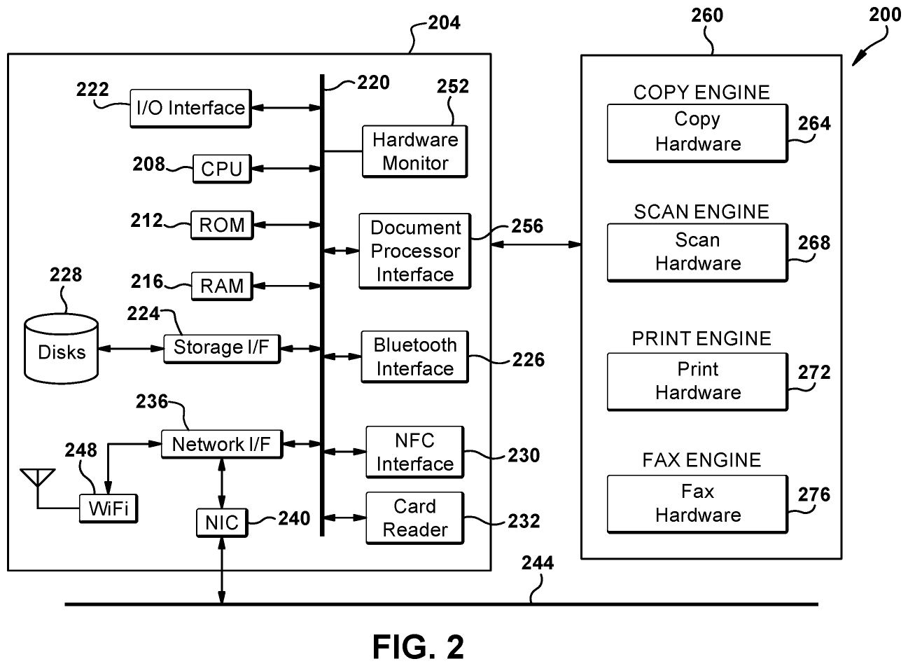

Turning now to FIG. 2, illustrated is an example embodiment of a networked digital device comprised of document rendering system 200 suitably comprised within an MFP, such as with MFP 104 of FIG. 1. It will be appreciated that an MFP includes an intelligent controller 204 which is itself a computer system. Thus, an MFP can itself function as a server with the capabilities described herein. Included in intelligent controller 204 are one or more processors, such as that illustrated by processor (CPU) 208. Each processor is suitably associated with non-volatile memory, such as read-only memory (ROM) 212, and random access memory (RAM) 216, via a data bus 220.

Processor 208 is also in data communication with input/output interface 222, suitably comprising a user touchscreen. While touchscreens are discussed in example embodiments herein, it is to be appreciated that any suitable user interface, such as keyboards, switches, displays, trackballs or mice may be used.

Processor 208 is also in data communication with a storage interface 224 for reading or writing to a storage 228, suitably comprised of a hard disk, optical disk, solid-state disk, cloud-based storage, or any other suitable data storage as will be appreciated by one of ordinary skill in the art.

Processor 208 is also in data communication with additional interfaces, such as Bluetooth interface 226, NFC interface 230 and card reader 232 for data exchange with proximity cards, such as card keys.

Processor 208 is also in data communication with a network interface 236 which provides an interface to a network interface controller (NIC) 240, which in turn provides a data path to any suitable wired interface or physical network connection 244, or to a wireless data connection via wireless network interface 248. Example wireless network interfaces include optical, cellular, Wi-Fi, wireless universal serial bus (wireless USB), satellite, and the like. Example wired interfaces include Ethernet, USB, IEEE 1394 (FireWire), Lightning, telephone line, or the like.

Processor 208 can also be in data communication with any suitable user input/output (I/O) network interface 222 which provides data communication for interfacing with user peripherals, such as displays, keyboards, mice, track balls, touch screens, or the like. Processor 208 can also be in communication with hardware monitor 252, such as a page counter, temperature sensor, toner or ink level sensor, paper level sensor, or the like.

Also in data communication with data bus 220 is a document processor interface 256 suitable for data communication with the document rendering system 260, including MFP functional units. In the illustrated example, these units include a scan engine comprising copy hardware 264, a scan engine comprise of scan hardware 268, a print engine comprised of print hardware 272 and a fax engine comprised of fax hardware 276 which together comprise document rendering system 260. It will be understood that functional units are suitably comprised of intelligent units, including any suitable hardware or software platform.

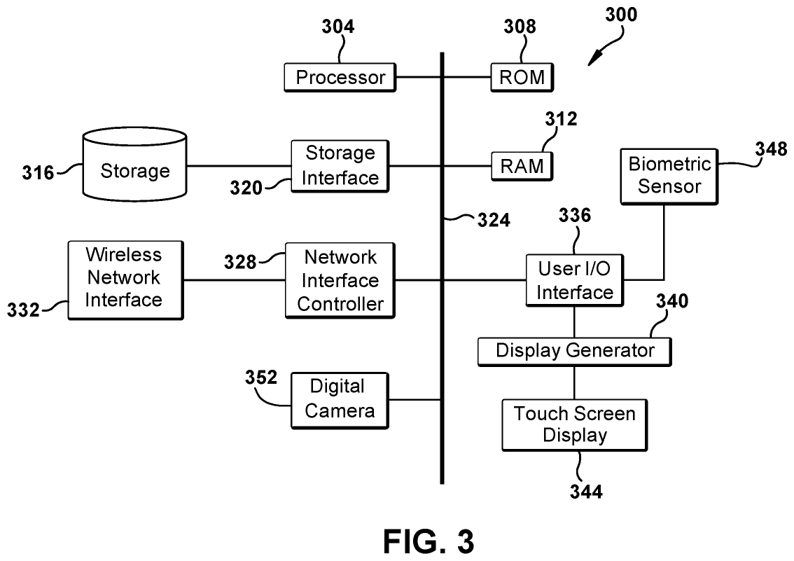

Turning now to FIG. 3, illustrated is an example embodiment of a digital data processing device 300 such as public mail server 114, black list file server 140 and administrator workstation 144 of FIG. 1. It is to be appreciated that some components listed may be unnecessary in certain configurations. Components of the digital data processing device 300 suitably include one or more processors, illustrated by processor 304, memory, suitably comprised of read-only memory 308 and random access memory 312, and bulk or other non-volatile storage 316, suitably connected via a storage interface 320. Data communication among components is accomplished via data bus 324. A network interface controller 328 suitably provides a gateway for data communication with other devices, via any wireless or wired connection, such as via wireless network interface 332. A user input/output interface 336 is suitably comprised of display generator 340 interfacing with touchscreen display 344. As noted above, any suitable user input and display can be used. User input/output interface 336 also provides connection to biometric sensor 348, suitably comprised of a fingerprint sensor, retinal sensor, or the like, and may be used to secure device access to one or more users. Processor 304 processor is also in data communication with a digital camera 352, suitably used to capture images which may include encoded images such as barcodes or QR codes. Digital camera 352 is also suitably used for facial recognition, including facial recognition for securing device access.

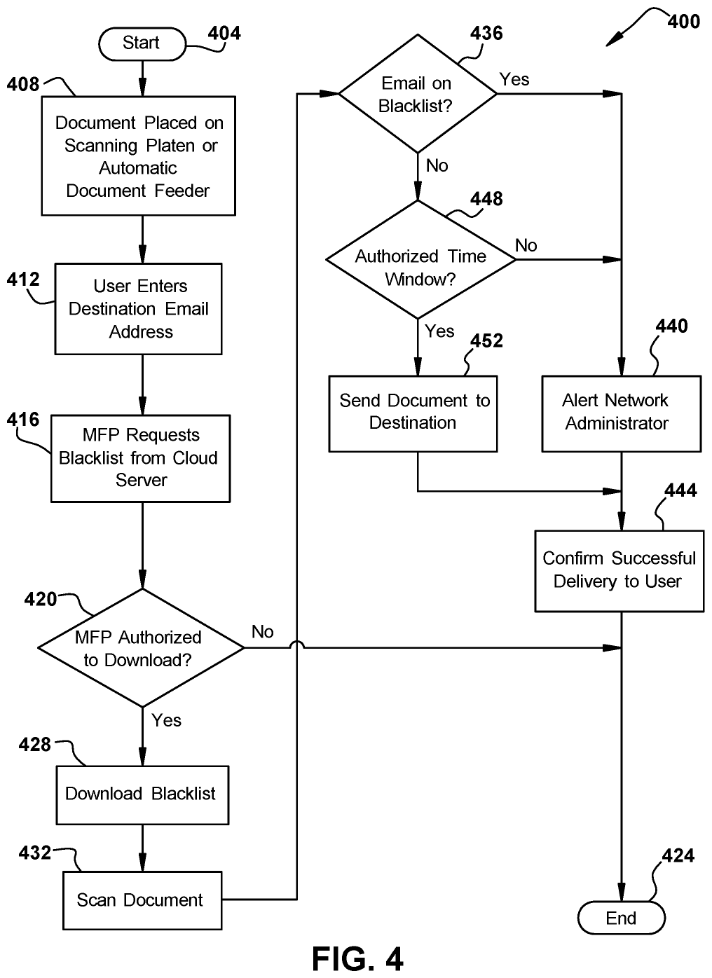

FIG. 4 illustrates flowchart 400 of an example embodiment of a system for implementing a cloud-based scan to email blacklist screening for scan to email operations. The system starts at block 404 and proceeds to block 408 where a document is placed on a scanning platen or an automated document feeder of an MFP for scanning. A user enters a destination email address at block 412 and the MFP requests a blacklist from a cloud server at block 416. If it is determined at block 420 that the requesting MFP is not unauthorized for a download, such as not being pre-registered by its IP address or subnet, the process ends at block 424. If the MFP is authorized, the blacklist associated with the MFP or subnet is downloaded at block 428.

Next, the user's document is scanned at block 432 and a determination is made at block 436 whether a domain associated with destination email address is on the blacklist. If so, a network administrator is notified at block 440. The user may be told that the email was delivered to the specified address, even though it was not, at block 444 to give an administrator time to react. The process then ends at block 424. If the email address is determined to not be on the blacklist at block 448, there may be a time window when sending to the specified email address is impermissible even if the address is not on the blacklist. By way of example, destinations may be blocked while an office is closed, late at night or on weekends when employee actions may not be readily observable. If the request is determined at block 448 to be in an authorized time window, or if no time window is specified, the scan document is sent to the requested destination at block 452, delivery is confirmed at block 444 and the process ends at block 424.

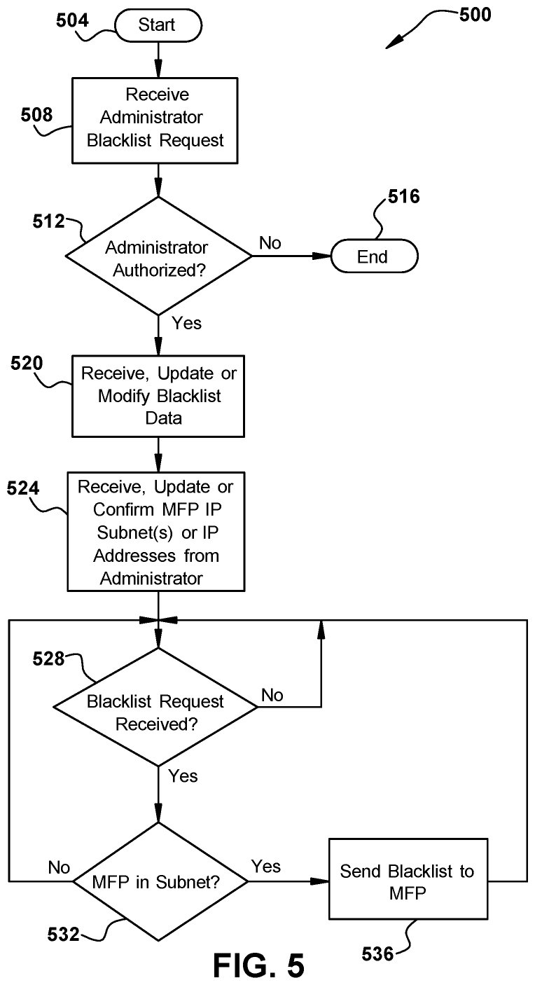

FIG. 5 illustrates a flowchart 500 of an example embodiment of creating and accessing a cloud server blacklist. The process commences at block 504 and proceeds to block 508 where an administrator logs into a blacklist cloud server. A test is made at block 512 to determine whether the administrator is authorized to act on a black list. Any suitable verification means can be used, alone or in combination, such as login credentials, biometrics, voice recognition and subnet verification. If the administrator is not authorized, the process ends at block 516. If the administrator is authorized, the process proceeds to block 520 where the administrator can receive, update or modify blacklist data. The process then proceeds to block 524 where the administrator can set parameters for MFP access to their blacklist. This can be done by setting a subnet. Any other suitable verification scheme can be used, such as authorizing individual IP addresses or password protection.

The process moves to block 528 where it remains until an MFP blacklist request is received. A test is made to determine whether the request is from an MFP in the pre-authorized subnet at block 532. If not, the process returns to block 528 until another blacklist is requested. If the requesting MFP is in the authorized subnet, the blacklist is sent to the MFP at block 536 and the process returns to block 528.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A multifunction peripheral comprising:
a processor and associated memory;
a network interface;
a document processing engine including a scanner;
a user interface including a display and a user input;
the processor configured to generate an electronic document from a tangible document via the scanner in accordance with an instruction received via the user interface;
the processor further configured to receive an email address for transmission of the electronic document via the user interface;
the processor further configured to download blacklist data from an associated blacklist server via the network interface;
the processor further configured to determine whether a domain associated with the email address exists in the blacklist data;
the processor further configured to send the electronic document to the email address via the network interface when the domain does not exist in the blacklist data; and
when the domain exists in the blacklist data, the processor further configured withhold delivery of the electronic document to the email address and to send to an associated administrator, via the network interface,
data identifying the multifunction peripheral,
timing data identifying a timing of attempted transmission of the electronic document, and
a copy of the electronic document.

2. The multifunction peripheral of claim 1 wherein the data identifying the multifunction peripheral includes an IP address of the multifunction peripheral and a location of the multifunction peripheral on a premises.

3. The multifunction peripheral of claim 2 wherein the processor is further configured to receive the blacklist data in accordance with blacklist information supplied to the associated blacklist server by the associated administrator.

4. The multifunction peripheral of claim 3 wherein the processor is further configured to generate an image on the display indicative of a successful transmission of the electronic document to the email address irrespective of whether the domain exists in the blacklist data.

5. The multifunction peripheral of claim 4 wherein the processor is further configured to send an identity of a user to the associated administrator via the network interface when the domain exists in the blacklist data.

6. The multifunction peripheral of claim 3 wherein the processor is further configured to selectively withhold delivery of the electronic document to the email address in accordance with the timing data.

7. The multifunction peripheral of claim 1 wherein the domain is associated with a public mail server.

8. A method comprising:
scanning a tangible document into an electronic document via a scanner in accordance with an instruction received from a user via a user interface;
receiving an email address for transmission of the electronic document from the user via the user interface;
downloading into memory blacklist data from an associated blacklist server via a network interface;
determining whether a domain associated with the email address exists in the blacklist data;
sending the electronic document to the email address via the network interface when the domain does not exist in the blacklist data; and
when the domain exists in the blacklist data, withholding delivery of the electronic document to the email address, sending to an associated administrator, via the network interface,
data identifying a multifunction peripheral,
timing data identifying a timing of attempted transmission of the electronic document, and
a copy of the electronic document.

9. The method of claim 8 wherein the data identifying the multifunction peripheral includes an IP address of the multifunction peripheral and a location of the multifunction peripheral on a premises.

10. The method of claim 9 further comprising receiving the blacklist data in accordance with blacklist information supplied to the associated blacklist server by the associated administrator.

11. The method of claim 10 further comprising generating an image on a display indicative of a successful transmission of the electronic document to the email address irrespective of whether the domain exists in the blacklist data.

12. The method of claim 11 further comprising sending an identity of the user to the associated administrator via the network interface when the domain exists in the blacklist data.

13. The method of claim 10 further comprising selectively withholding delivery of the electronic document to the email address in accordance with the timing data.

14. The method of claim 8 wherein the domain is associated with a public mail server.

15. A system comprising:
a memory storing blacklist data associated with blacklisted domain names;
a processor configured to receive a blacklist request from an associated multifunction peripheral via a network interface;
the processor further configured to determine whether the associated multifunction peripheral is permitted to receive the blacklist data;
the processor further configured to send the blacklist data to the associated multifunction peripheral when it is permitted and withhold the black list data when it is not permitted.

16. The system of claim 15 wherein the processor is further configured to receive, transmit update or modify the blacklist data via the network interface with an authorized administrator associated with the associated multifunction peripheral.

17. The system of claim 16 wherein the processor determines whether the associated multifunction peripheral is permitted to receive the blacklist data in accordance with an IP address associated with the associated multifunction peripheral.

18. The system of claim 17 wherein the processor determines whether the associated multifunction peripheral is permitted to receive the blacklist data when the IP address exists in a preselected subnet specified by the authorized administrator stored in the memory.

19. The system of claim 15 wherein the blacklist data includes data corresponding to one or more public email servers.

20. The system of claim 19 wherein the one or more public email servers include one or more of Gmail, HubSpot, Sendinblue, ProtonMail, Outlook, Yahoo Mail, Zoho Mail, Mail.com, GMX Mail, iCloud Mail and Yandex Mail.
